(19) United States
(12) Patent Application Publication
(10) Pub. No.: US 2010/0062288 A1
(43) Pub. Date: Mar. 11, 2010

(54) System for generation of useful electrical energy from isotopic electron emission

(76) Inventors: David Weber, Lauderdale Lakes, FL (US); John Cochrane, Lauderdale Lakes, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 11/601,493

(22) Filed: Nov. 17, 2006

Related U.S. Application Data
(60) Provisional application No. 60/737,931, filed on Nov. 18, 2005.

(51) Int. Cl. H01M 2/00; H01M 14/00

(52) U.S. Cl. 429/10; 429/5

(57) ABSTRACT

Beta and alpha-ray particles emitted by radio-isotopic by-products of nuclear fission, such as nickel 63, are used as a power source at the cathode of a microwave generating magnetron. Such particles include high speed, high energy electrons having a large EMF associated therewith. In the magnetron, a radial electrical vector, between the cathode and anode, interacts with an axial magnetic vector to produce a cloud of electrons that rotates about the magnetron axis. The speed, geometry and density of the rotating cloud may be modulated by an external RF input or grids within the interaction space of the magnetron. At the periphery of the interaction space is a polar array of anode cavities into which the rotating field induces an LC equivalent parameter that includes high energy microwaves that may be used as an input for the generation of AC or DC power.

### CROSS REFERENCE TO RELATED APPLICATION

This application claims the benefit under 35 USC 119(e) of Provisional Patent Application Ser. No. 60/737,931, filed Nov. 18, 2005, and the same is incorporated by reference herein in its entirety.

### BACKGROUND OF THE INVENTION

A. Area of Invention

The use of beta or alpha particles of radio isotopic elements that are typically by-products of nuclear fission are used as a power source for the generation of electricity.

B. Prior Art

Beta particles are a category of electrons emitted from a neutron of an atomic nucleus during its decay. Over a period, known as the isotope half life, a neutron of a decaying nucleus is converted into a proton, increasing by one the atomic number of the nucleus thereby increasing by one step in the periodic table an atom subject to such decay. The decay of the neutron may, in rare circumstances, result from a natural process. However, most such decay is the result of exposure of the nucleus to extreme conditions of heat and exposure to other sub-atomic particles, as often occur during nuclear fission. Such external conditions induce an instability into the basic quark structure of the neutron which normally consists of one so-called up (u) quark and two so-called (d) down quarks. In beta decay, the intra-nucleon electro-weak force W degrades one of the d quarks into an u quark creating, during the half life of the isotope, a structure of one d quark and two u quarks, that is, the quark structure of a proton. This causes the one step up in the periodic table of the atomic number of the affected nucleus.

The modern theory of beta decay was developed in 1934 by Enrico Fermi, but was not experimentally proven until 1956 by T. D. Lee and C. N. Yang. This process, as now understood, can be expressed by a Feynman diagram showing one of the d quarks of the decaying neutron transformed by an electro-weak interaction W into an u quark, from which reaction is released one electron and one anti-neutrino. This additional particle is necessary to express beta decay in terms that do not violate the principles of conservation of energy and momentum in sub-atomic interactions.

A neutron, unassociated with a nucleus, will decay within a half life of about 600 seconds, but is stable if combined into a nucleus. When so combined with protons and other neutrons, it is governed by the nuclear strong force, and beta decay of the neutron would normally occur only over a period of many years, often centuries. When a neutron has fully decayed into a proton, a mass difference (decrease in energy of about 1.29 Mev) results, this representing the energy equivalent of the mass of the neutron which is lost during the above-described conversion of the d to an u quark. It has been shown that the beta decay electron carries away most of said energy difference in the form of kinetic energy and a strong magnetic field around the electron.

The present invention seeks to make effective and efficient use of such high energy electrons resultant of neutron decay and the electro-weak interaction within the quark structure of the neutron which causes the decay.

Since the most accessible form of beta decay neutrons is that of the radio-isotopic by-products of nuclear fission, the instant invention may be appreciated in terms of a new use of these by-products, e.g., iron 55, nickel 63, strontium 90, tritium and others, as a power source or input, to a microwave radiation device known as a magnetron tube or simply, magnetron. The magnetron, as a source of microwaves, has existed since its discovery in the 1930s by Randall and Boot. The magnetron became a building block of what is now termed cavity magnetron microwave radar. The magnetron is also the basis of the standard microwave oven.

Methods and apparatus for the direct conversion of radiation of radio-isotopes including beta decay electrons, to electrical energy was first suggested in 1988 by the physicist Paul M. Brown, and is reflected in his U.S. Pat. No. 4,835,433, directed to a resonant circuit battery using a radio isotope inside a coil of a tank circuit. The invention of Brown sought to employ the so-called beta voltaic effect to access the electrical potential associated with energy in the magnetic field of high energy beta electrons. See www.rexresearch.com/nucell/nucell.htm. Isotopes which emit beta electrons occur within fuel rods of fission reactors and in the processing of uranium 238 and plutonium. Beta electrons are negatively charged and travel at a high velocity, approximately ¾ the speed of light (0.75 c), and exhibit an energy spectrum up to 0.782 MeV with a maxima at a lower level.

In the nucleus of most naturally occurring elements, neutrons cannot decay because there is no available quark orbit for a decaying quark to occupy. As a result, most naturally-occurring nuclei are stable. However, when subjected to the high energy and extreme heat of nuclear fission, the d quark does decay, thus rendering the neutron unstable. As above noted, when this occurs, the nucleus emits at least an electron and an anti-neutrino. Electrons emitted in this fashion thus exhibit exceedingly high levels of energy since they must possess sufficient energy and velocity to escape from the quark orbits of the decaying neutron of which they were a part. As has been determined by Brown and others, the magnetic energy associated with beta radiation electrons is several orders of magnitude greater than either the kinetic energy of those electrons or the electric field energy of the same particles. As such, each emitted electron of a radio-isotope is associated with a powerful magnetic field which, if absorbed by a load, causes the field to collapse thus producing an EMF known as the beta voltaic effect. This field may however be used in a magnetron environment to produce a high energy rotating field and to induce microwaves, as is set forth below.

One of the primary drawbacks to the use of nuclear power is the radioactive waste which results from its fission process. Much of the waste of the system is in the form of “spent” fuel rods which cannot efficiently sustain the fission reaction process in the reactor. After serving their useful lives, the spent fuel rods are removed from the reactor, but the fuel rods still possesses a significant amount of their original energy capability, particularly in the electro-weak force W that acts within the nucleons. Even after removal from the reactor, the fission process continues in the fuel rods and strong force (inter-nucleon) energy continues to be released, mainly in the form of kinetic energy which is subsequently converted to heat. Some of this energy will however affect the neutron nucleons, stimulating neutron decay which gives rise to the beta decay noted above. Thus, the fuel rods continue to produce energy as they undergo radioactive decay, meaning they are still “hot” in terms of hard radiation. The rods, therefore, must be isolated until they are no longer radioactive, which can take thousands of years or more. There are no final procedures for the storage of spent fuel rods and other radioactive material. That is, no steps are underway to make use of the massive amount of radioactive decay energy, including beta decay energy, that exists in radioactive materials, especially in spent fuel rods and plutonium by-products. Thus, there remains a need for a method of safely and efficiently utilizing the decay particles of radio-isotopes, both beta and otherwise.

Other attempts have been made to convert radioactive decay energy to electrical energy, however, none have proved commercially viable due to their complexity, minimal power generating capability, or lack of durability. For example, a solid-state device which seeks to employ the energy associated with alpha and beta particles at a Fermi junction is taught by U.S. Pat. No. 5,825,839 (1998) to Baskis. It teaches that the energy associated with alpha and beta particles are in a range of 1000 to nearly one million KV (1 MeV) per particle, that is, six to twelve orders of magnitude greater than the voltage of an electron at rest. Radio-isotopes as a power source in micromechanical, i.e., nano-structures, are addressed in U.S. Pat. No. 6,479,920 (2002) to Lal, et al. The primary deficiency of these devices has been degradation of the structures by long term exposure to the high kinetic energies of the beta electrons. As such, physical durability is a key design factor in building a commercially viable beta electron device which, preferably, would take the form of a battery that is size-scalable up or down as a function of application.

No prior art known to the inventors set forth a method and apparatus for the conversion of energy associated with the electro-weak force or the beta voltaic effect into high energy microwaves and, in turn, use of such microwaves as an input for the evaporation of liquid as an input to an electrical turbine generator or, alternatively, use of such a microwave magnetron output as an input to microwave DC generators known in the art. The present invention addresses this need.

### SUMMARY OF THE INVENTION

Beta electrons and alpha-ray particles emitted by radio-isotopic by-products of nuclear fission, such as nickel 63, are used as a power source at the cathode of a microwave generating magnetron. Such particles include high speed, high energy electrons having a large EMF associated therewith. In the magnetron, a radial electrical vector E, between the cathode and anode, interacts with an axial magnetic vector B to produce an E×B force that rotates the beta electrons about the magnetron axis at which the cathode is located. The speed and geometry of the rotating field may be modulated by an external RF input biasing of the anode and the use of circumferential grids between the cathode and anode. At the internal periphery of the magnetron is a polar array of anode cavities into which the rotating field induces an LC value which excites the cavities, producing microwave resonance which may be used as an input for the direct or indirect generation of AC or DC power.

This invention thus relates to a system for generation of electrical energy, the system comprising: a cathode comprising an axially disposed emitter of electrons resultant of an electro-weak decay of the quark structure of neutrons of an atomic nucleus of an isotope; an annular anode block, disposed in an axial plane and having an opposite electrical polarity relative to said cathode, forming between said cathode and anode block a DC radial electrical vector E, said anode block circumferentially disposed in said plane about said cathode, and having an interior radius relative to said cathode defining an annular interaction space, an outer periphery of said space defining a polar array of anode cavities in said block, separated from each other by anode surfaces, each cavity and surface together having an LC equivalent value, each cavity capable of generating a resonant frequency responsive to motion of said electrons past said anode surfaces and entrances to said anode cavities; upper and lower magnets, each of opposite polarity, each disposed in respective radial planes, above and below said anode block, in which opposing surfaces of said upper and lower magnets are in magnetic communication with said interaction space of said anode block, producing a DC magnetic vector B therebetween and axially across said anode block in a direction co-axial with each of said cavities within said anode block in which said beta electrons interact with an E×B vector, produced by said electrical and magnetic vectors, causing rotation of said electrons to form a rotating electron cloud within said annular interaction space and inducing microwave energy at LC resonant frequencies into said anode cavities; and a power port for feeding resonant microwave energy from said cavities assembly for conversion thereof into a power output of said system.

It is an object of the invention to provide a safe and cost-effective means of conversion of isotopic electron emission into useful electric energy.

It is another object to provide a system for use of beta electron neutron decay as a power source for an electric generator or battery.

It is a still further object to provide a system of the above type having sufficient durability for use without maintenance during a period of at least two years.

The above and yet other objects and advantages will become apparent from the hereinafter set forth Brief Description of the Drawing, Detailed Description of the Invention and Claims appended herewith.

### BRIEF DESCRIPTION OF THE DRAWINGS

FIG. 1 is a perspective schematic view of an anode block of a conventional magnetron.

FIG. 2 is a vertical radial cross-sectional view of a conventional magnetron.

FIG. 3 is an axial schematic view of a radial cross-section of a magnetron in accordance with the present invention.

FIG. 4 is an exploded view of portions of the magnetron of FIG. 3.

FIG. 5 is a partial vertical cross-sectional view of the magnetron of FIGS. 3-4 and its waveguide interface.

FIG. 6 is a view, similar to that of FIG. 3, showing strapping rings of the magnetron.

FIG. 7 is an axial fragmentary view of a radial cross-section of a hole-and-slot type magnetron.

FIG. 8 is a polar segment of the view of FIG. 1.

FIG. 9 is a view of an equivalent LC resonant circuit of the structure of FIGS. 1 and 8.

FIG. 10 is a view, similar to that of FIGS. 3 and 6, also showing a rotating electron cloud pattern in the interaction space of the magnetron of FIGS. 3-6.

FIG. 11 is a view, similar to that of FIG. 10, but relative to a magnetron of the type of FIG. 7.

FIG. 12 is an axial view of the radial cross-section of the magnetron of FIG. 7, and including the power exit port thereof.

FIG. 13 is a schematic partial fragmentary view of the structure of FIGS. 11-12, showing the effect of an RF input upon the electron cloud pattern in a magnetron.

FIG. 14 is an axial view of a radial cross-section of a rising-sun type anode block.

FIG. 15 is a systems view of the present invention.

FIG. 16 is an assembly view of FIG. 4, however showing the use of a dielectric offset between the upper and lower magnets.

FIG. 16A is a vertical cross-sectional view taken along Line 16A-16A of FIG. 16.

FIG. 17 is an embodiment of the structure of FIGS. 3, 4, 6 and 14 in which concentric grids are positioned in the interaction space to control electron velocity and curvature of rotation.

FIG. 18 is a vertical exploded view taken along Line 18-18 of FIG. 17.

FIG. 19 is a vertical cross-sectional view of a further embodiment of the invention.

FIG. 20 is a perspective view of another embodiment of the invention.

FIG. 21 is a flattened view of the anode array of an anode block of an axial segment of the embodiment of FIG. 20.

FIG. 22 is a view of another embodiment of FIG. 21 showing the use of different geometries for each cavities.

FIGS. 23 and 24 are fragmentary views of parts of FIG. 22.

FIG. 25 is a schematic view showing use of antennae in lieu of cavities as system resonators

### DETAILED DESCRIPTION OF THE INVENTION

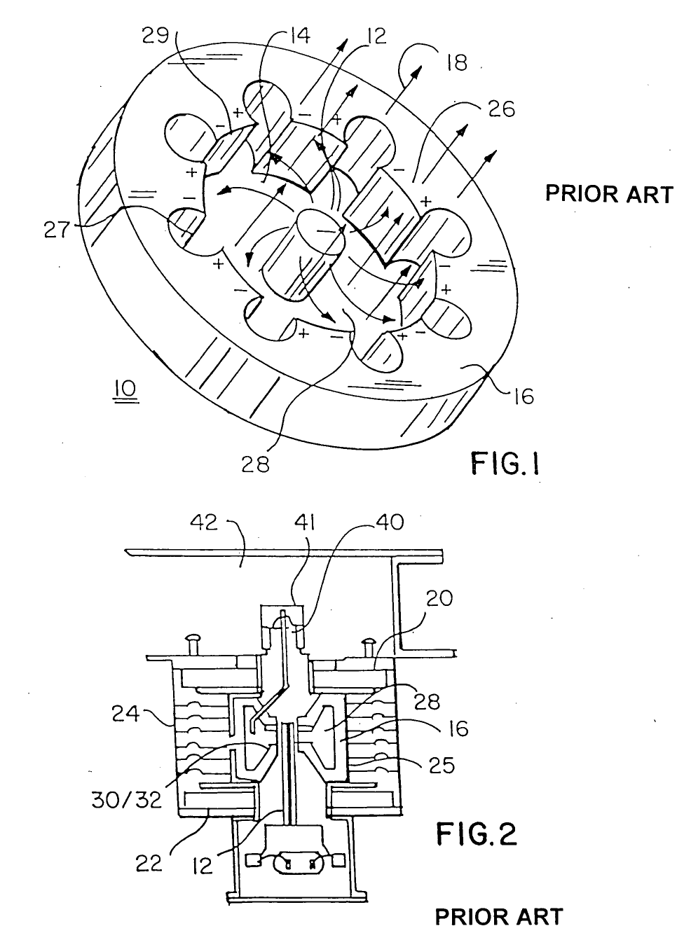

With reference to FIG. 1, there is shown one form that an anode and cathode structure of traditional magnetron 10 may take. In this structure, an axially located cathode 12 employs thermionic emission to release electrons 14 which travel outwardly in the direction of anode block 16 which includes anode cavities 27, interaction space 28 and anode poles 29. The otherwise natural radial paths of the electrons are deflected by a linear DC magnetic field 18 which is generated by upper and lower magnets 20 and 22 (see also FIG. 2) of polarity opposite each other. FIG. 2 is a vertical radial cross-sectional view of a typical magnetron which includes said cathode 12 and anode block 16. Cooling fins 24 typically extend integrally outwardly from an outer periphery 25 of the anode block. Also shown in FIG. 2 are interaction space 28, output antenna 40, vacuum power port 41, waveguide 42 and strap rings 30/32, more fully described below.

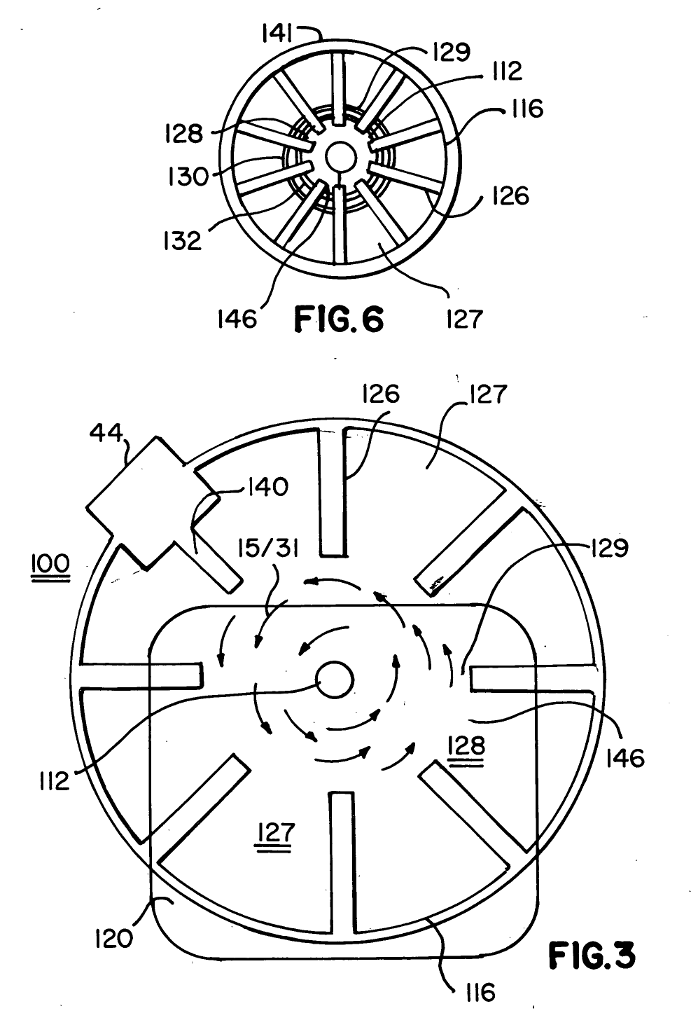

It may be appreciated that electrons 14 would travel radially outwardly to anode poles 29 were it not for the transverse DC magnetic field 18 which deflects the emitted electrons to the left because the (E×B) cross-vector resultant from the interaction of the radial electric field of electrons with the transverse DC magnetic field 18. Thus, electrons 14 tend to sweep around annular interaction space 28 between the cathode 12 and poles 29 of the anode block 16. This circular motion is shown in FIG. 3 which also illustrates the radial geometry which an anode block 116 of a fin or stub type magnetron 100 may take. Therein, anode cavities 127 are formed between anode stubs 126, at the end of which are poles 129. These cavities are trapezoidal as opposed to the cavities 27 of the magnetron 10 (see FIG. 1) which are semi-circular in radial cross-section. FIG. 3 also shows rotating electron cloud pattern 128 and a RF port 44, later described.

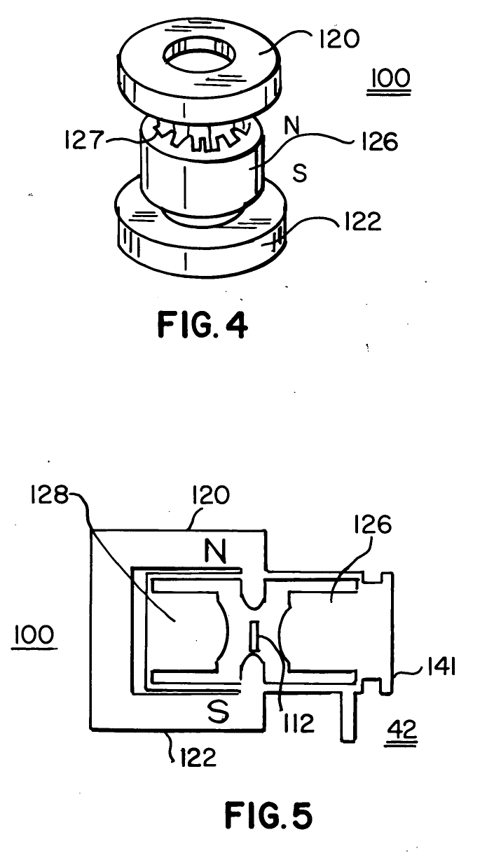

In the present invention, there is used a radio-isotope cathode 112 which emits high energy electrons 15. An exploded view of magnetron 100 is shown in FIG. 4, which also shows DC magnets 120 and 122, and cavities 127. FIG. 5 is a vertical fragmentary radial view of the magnetron of FIG. 3, showing interaction space 128, stubs 126, DC magnets 120 and 122, vacuum port 141, cathode 112 and waveguide 42. In FIG. 6 is shown, in radial cross-sectional view, an actual magnetron of the type shown schematically in FIG. 3. Therein may be seen anode block 116, anode fins or stubs 126, trapezoidal anode cavities 127, the isotopic cathode 112, anode poles 129 and two sets of shorting straps 130 and 132, the function of which is explained below. Also shown in FIG. 6 is interaction space 128 between cathode 112, and anode stubs 126 and poles 129.

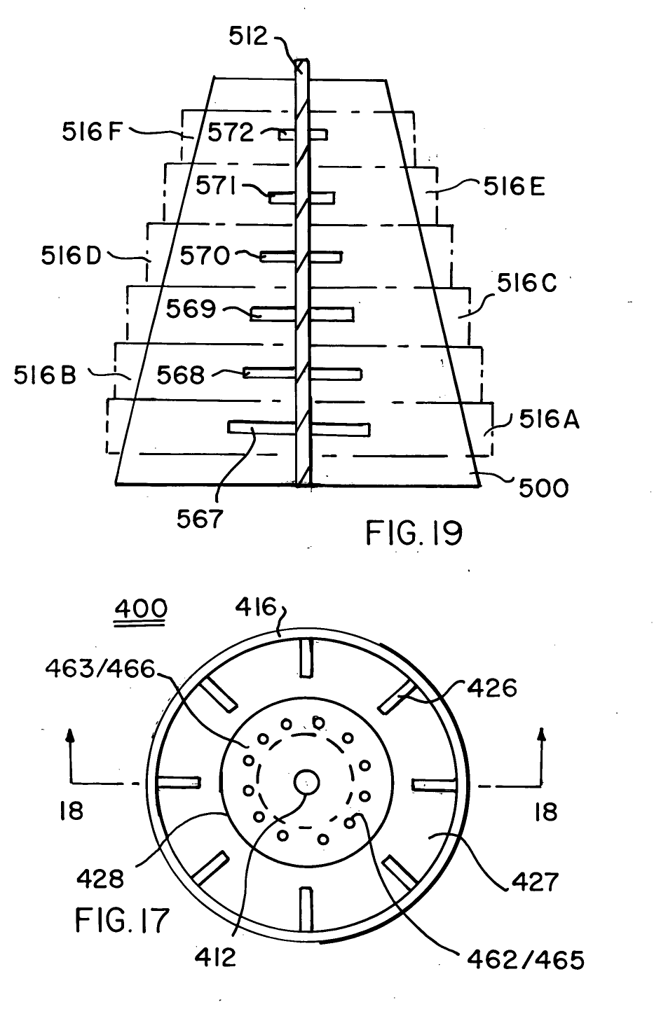

In FIG. 16 is shown an assembly view of the magnetron 100 of FIG. 4. Shown therein are strips 160 of a non-conductive or dielectric material such as a polycarbonate, silicone, or the like. The structure thereof may be more fully appreciated with reference to the vertical cross-sectional view of FIG. 16A-16A in which interaction space 128 may also be seen (see also FIGS. 5 and 10). It may, from FIG. 16A, be appreciated that, in a given embodiment, the axial height of interaction space 128 may be very narrow while in other embodiments, such as those shown in FIGS. 4 and 5, it may be closer in dimension to the radius of the interaction space.

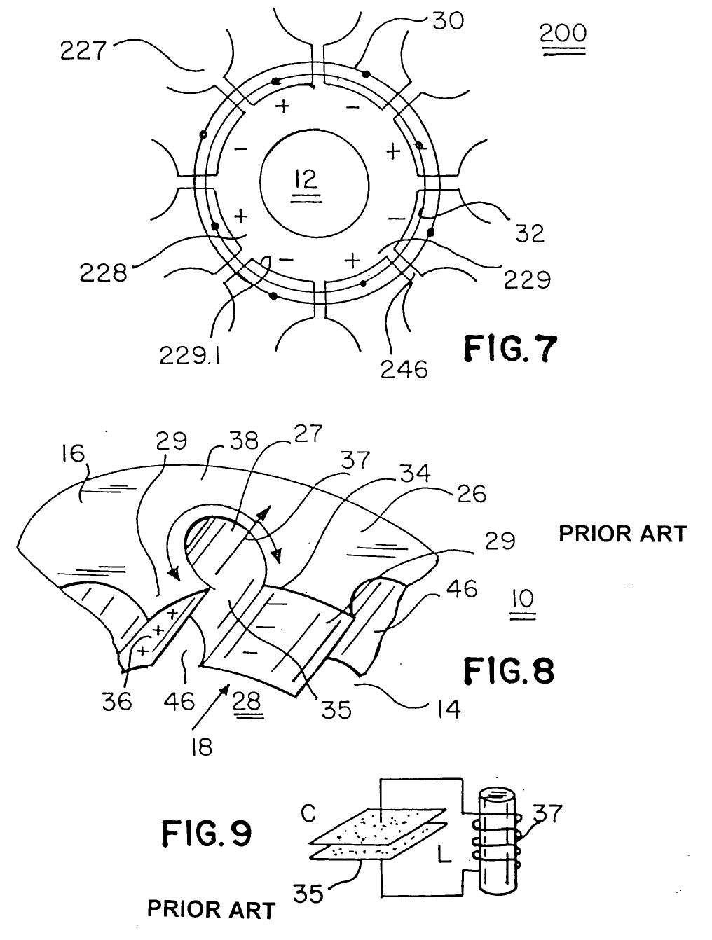

Strapping 30/32 is shown in more detail in the hole-and-slot magnetron 200 shown in FIG. 7. As may be noted, positive poles 229 are tied to each other by inner strap 32 while negative poles 229.1 are tied to each other by strap 30. Strapping of respective pole pairs assures a desired phase relation of respective spokes of the rotating cloud (see FIGS. 10 and 11) and uniformity of amplitude of each spoke. This facilitates the summary of combining the power output of each cavity. Each strap 30 and 32 may then be connected to a power port output of the system.

The effect of the rotation of electrons 15 is shown in the views of FIGS. 8 to 11. More particularly, the isotope input to the magnetron 100/200 is applied at center cathode 112 from which high speed (75 c), high energy electrons 15 are released by neutron decay from the radioisotope. Nickel 63 may be employed because of its particular property of high rate of release of beta ray electrons, safety and reasonable cost. The inventive system thus employs a cold cathode requiring no external heat or power source. As noted above, beta rays are produced by the radioactive decay of neutrons of certain naturally occurring elements but, particularly, by man-made by-products of fission in nuclear power plants in the and production of plutonium. Nickel 63 gives off no alpha or gamma radiation, so that its use does not necessitate thick lead shielding or the like for safety purposes or alpha-specific shielding. As noted in the Background of the Invention, the magnetic energy given off by beta electrons possesses energy several orders of magnitude greater than either the kinetic energy or the direct electric charge of the electron, and far greater than that of electrons resultant of the thermionic emission of prior art magnetron cathodes.

It is to be appreciated that any moving electrically charged particle, e.g., an electron, will behave like a current and thus yield a symmetric magnetic field in which energy is stored and thus carried by the particle. Absorption of such a charged particle causes its magnetic field to collapse the energy of which is considerable, as above noted. As set forth in U.S. Pat. No. 4,845,433 to Brown (see Background of the Invention above) an LC resonant tank circuit oscillation at a self-resonant frequency uses energy contributed by the beta voltaic effect, providing a resonant nuclear battery to convert beta electron energy into electricity. The within invention however employs the unique function of LC resonant microwave cavities of a magnetron which are more efficient and durable than the LC resonant tank circuit taught by Brown. This may be seen with reference to the description which follows:

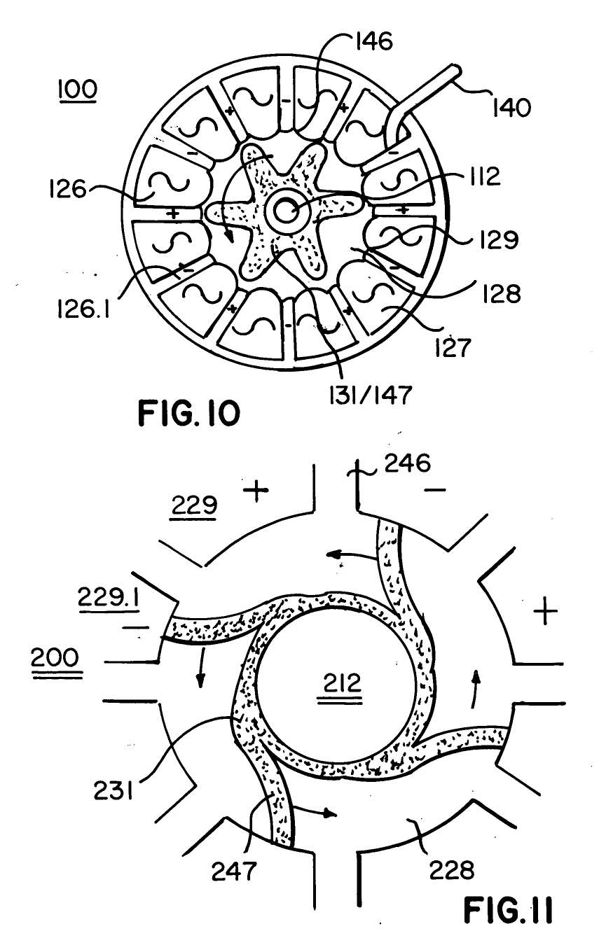

In FIG. 8 is shown an enlarged fragmentary view of the magnetron 10 of FIG. 1. Therein are shown anode block 16, anode cavities 27, anode stubs 26, and anode poles 29. Some of the electrons 15 emitted from the isotope cathode eventually reach anode pole 29 or become a part of a whirling cloud 131/231 of electrons, within the interaction space 128/228 (see FIGS. 10-11), having both radial and polar velocity components. In most cases, however, the polar component of momentum (produced by the above-referenced E×B vector) will predominate, causing the counterclockwise electron rotation shown in FIGS. 3, 10 and 11. With further reference to FIG. 8, electrons 15 will arrive from the cathode at a negatively charged region 34 of the anode pole 29 and, in so doing, will tend to “pump” the natural resonance frequency of the cavities 27 in two ways: Firstly, by forming a virtual capacitor across slot 46 between said negatively charged region 34 and a positively charged region 36 (which is induced upon the opposing side of the next anode pole 29). Opposing charge regions 34 and 36 at opposite sides of slots 46 of each anode cavity 27 thus yield a capacitive effect 35. (See FIG. 8) Concurrently, the difference in charge between regions 34 and 36 produces a current flow 38 around cavity 27 and, because of the geometry of this current flow, an inductive effect 37 transverse to cavity 27 is produced. Resultantly, the sweep/rotation of electron field 31 within interaction space 28 causes each cavity 27 to exhibit a resonance which is analogous to that of parallel resonant circuit, as shown in FIG. 9. Therein, the resonant frequency is expressed by the formula:

$${f}_{resonance} \approx \frac{1}{2 π} \sqrt{\frac{1}{LC}}$$

In the process of electron rotation, work is done on the electron charges because the axial magnetic field 18 of magnets 20 and 22 exerts force on electrons 15 which is perpendicular to their initial radial motion, thus causing them to be swept in the above noted annular motion by the (E×B) vector. In this manner, work is done upon the charges during their rotation. As the electrons sweep toward regions 34 of excess negative charge (see FIG. 8), a part of that charge is pushed around cavity 27, imparting both said inductive effect 37 and an oscillation which arises at the above-described natural frequency of the cavity. The driven oscillation of the charges past the anode cavities 27, regardless of their geometry, generates radiation of electromagnetic waves, typically in the microwave range, which are the output of every magnetron.

In FIGS. 2, 3 and 10 are shown antennae 40/140 which provide said waves, thru power port 41/141, to one or more waveguides 42 as described below.

FIGS. 10-11 show counter clockwise electron 131/231 of whirling electrons 15 as influenced by the above-described beta voltaic effect of isotope cathode 112 and the DC magnetic field between magnets 120 and 122. This forms a rotating pattern which, due to a property of the resonance cavities known as moding, produces a pattern which resembles spokes 147 of a spinning wheel. The interaction of this rotating space-charge pattern with the configuration of the surfaces of anode poles and anode cavities produces a specific alternating current flow in the cavities of the anode. That is, as a spoke 147 of electron pattern 131/231 approaches an anode stub 126 (see FIGS. 3, 5, 6 10, and 11) a positive (+) charge is induced in that stub 126, or in pole 229 in FIGS. 7 and 11. As the electrons pass, the positive charge diminishes in one stub, a negative charge is induced in the next stub 126.1 or pole 229.1. (See FIGS. 10-11). Current is induced in the cavity because of the physical structure of the cavity 127, as above described with reference to FIG. 8, producing the high Q resonant inductive-capacitive (LC) circuit of FIG. 9 in each cavity. The parallel relationship between the L and C parameters of the resonant cavities is secured through the so-called even and odd strapping 130 and 132 (see FIGS. 6 and 7) of alternate anode stubs 126 of the magnetron. In other words, the formula for resonant frequency above set forth with reference to FIG. 9 indicates that, in a given application, resonant frequency may be modified through (1) changes in the strapping, relationship of the resonant cavities of the system and (2) changes in the geometry of the cavities 27/127 or their gaps 46/146, (3) rate of rotation of the field 131 and its shape (see FIGS. 10-11) and (4) energy density of the field. For example, cavities 27 of FIGS. 1 and 8 will have a smaller capacitance across its gap than will the cavities of the magnetron 100 shown in FIGS. 3 and 10. Similarly, so-called hole-and-slot magnetron 200 of the type shown in FIGS. 7 and 11 will have a yet smaller capacitance than magnetron 10 because of the minimal width of the gap 246 between anode poles 229. By increasing the diameter or surface area of the cavities 27/127/227, the inductive effect will increase. In other words, a rotating magnetic pattern 131/231 of greatly increased energy, as will occur in the use of isotopic cathode 112, would require that an effective inductance and capacitance of the magnetron be provided in a relationship inverse to each other if one wished to obtain the same resonant frequency output into waveguides 42 as would occur in a conventional microwave. This might be essential if one wished to obtain the same 2.455 MHz frequency output which is efficient in the evaporation of water. Also, the strength of DC magnets 30/32 would also require increase, as might the radius of the interaction space 28/128, due to the high energy of beta electron 15.

An added significant factor in the behavior of rotating charge pattern 131/231 (see FIGS. 10 and 11) is the effect of the introduction of an RF field into interaction space 28/128, from RF port 44. (See FIG. 3). In fact, in the absence of an introduced external RF field, most electrons would either congregate at an anode pole 229.1 as is shown by the path of electron (a) in FIG. 13 or would quickly return to the cathode 212 as is shown by the path of electrons (b) in FIG. 13. However, the presence of the RF field naturally modifies these paths to facilitate the shape and rate of rotation of space-charged wheel pattern 131/231 within the interaction space 128/228. (See FIGS. 10-11). In FIG. 13, it is noted that electron (a) spends much more time in the RF field than do electrons (b). Electrons a are thus retarded and, therefore, the force of the DC magnetic field on then is diminished; as a result, they can now move closer to the anode pole 229. Under proper conditions, by the time electrons (a) arrive from point 1 at point 2, the RF field has reversed polarity, meaning electrons (a) will again be in a position to give energy to the RF field by being retarded by it. The force on electron (a) diminishes once more, and another RF interaction of this type occurs, this time at point 3, provided that at all times the RF field reverses polarity polar each time these electrons arrives at a suitable interaction position. In this manner, such “favored” electrons spend considerable time in the interaction space 228, and are capable of orbiting the cathode 212 several times before eventually arriving at an anode pole 229.

Electrons (b) undergo a totally different process. They are immediately accelerated by the RF field and, therefore, the force exerted upon them by the DC magnetic field increases. Electrons (b) thus return to the cathode even sooner than they would have in the absence of the RF field. They thus spend a much shorter time in the interaction space than electron (a). Although their interaction with the RF field takes as much energy from it as was supplied by electrons (a), there are far fewer interactions of the (b) type because these electrons are returned to the cathode after one, or possibly two, RF interactions. On the other hand, electrons (a) give up energy repeatedly. Therefore, more energy is given to the RF field than is taken from it, so that oscillations in the cavities 127/227 are sustained. The practical effect of electrons (b) is that they return to the cathode and tend to heat it.

Electrons in a magnetron also tend to bunch, this known as the phase-focusing effect, without which favored electrons (a) would fall behind the phase change of the RF field across the anode gaps 246 or slots 146 (see FIG. 10), since such electrons are retarded at each interaction with the RF field. Electrons (c) (see FIG. 13) contribute some energy to the RF field, but do not give up as much as electrons (a) because the tangential component of the field is not as strong at that point. As a result, these electrons are initially less useful than electrons (a). Electrons (c) encounter not only a diminished tangential RF field but also a component of the radial RF field, as shown in FIGS. 11 and 13. This has the effect of accelerating the electron radially outwardly, forming arms 247 of pattern 231 shown in FIG. 11. Immediately after this happens, the DC magnetic field exerts a stronger force on electrons (c) tending to bounce them back to the cathode 112 and also accelerating them in a counterclockwise direction. This, in turn, gives this electrons (c) a good chance of catching up with electrons (a). In a similar manner, electrons (d) (see FIG. 13) are retarded tangentially by the DC magnetic field and will therefore be overtaken by the favored electrons (a). Thus a bunching of electrons takes shape.

If an electron slips backward or forward, it will quickly be returned to a correct position with respect to the RF field, by the phase-focusing effect above described. FIG. 11 shows the wheel-spokes or arms 247 in the cavity magnetron. In the case shown, these arms rotate counterclockwise with the correct velocity to keep up with the RF phase changes between adjoining anode poles 229 and 229.1, so that a continued interchange of energy takes place, with the RF field receiving much more than it gives. As above noted, the RF field changes polarity and, thus favored electrons (a), by the time they arrive opposite the next gap or slot 246, see a positive anode pole 229 above and to the right, and see negative anode pole 229.1 to the left.

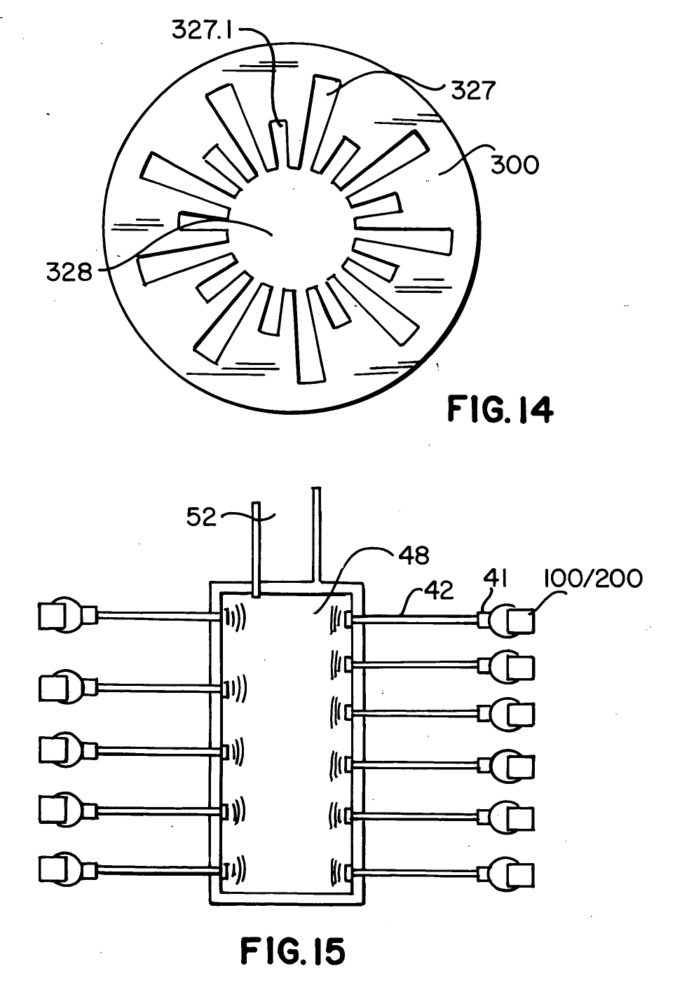

Should one wish to avoid the use of strapping or shorting rings 30/130 and 32/132 above described with reference to FIGS. 6 and 7, one may employ an anode block 300, shown in FIG. 14, in which alternating cavities 327 and 327.1 possess different radial dimensions. Therein larger cavities 327 are alternated with smaller cavities 327.1 to ensure that a suitable RF field is maintained in interaction space 328 and to avoid a phenomenon known as mode jumping. These differences in geometry between cavities 327 and 327.1 result in differences in resonant frequency that will be useful in tuning the magnetron of the present invention.

Another method of modulating the behavior of the magnetron entails alternating a DC voltage on the anode block to affect the capacitative and inductive values of the cavities. Also a technique, known as frequency pushing, may be used to affect the orbital velocity of the rotating electron cloud above-described with reference to FIGS. 10 and 11. This can be useful in adjusting the resonant frequency emitted by the cavities since change in the orbital velocity of the electron cloud will change the LC values of the resonant cavities. Thus a variable RF input will be useful in tuning the magnetron of the invention.

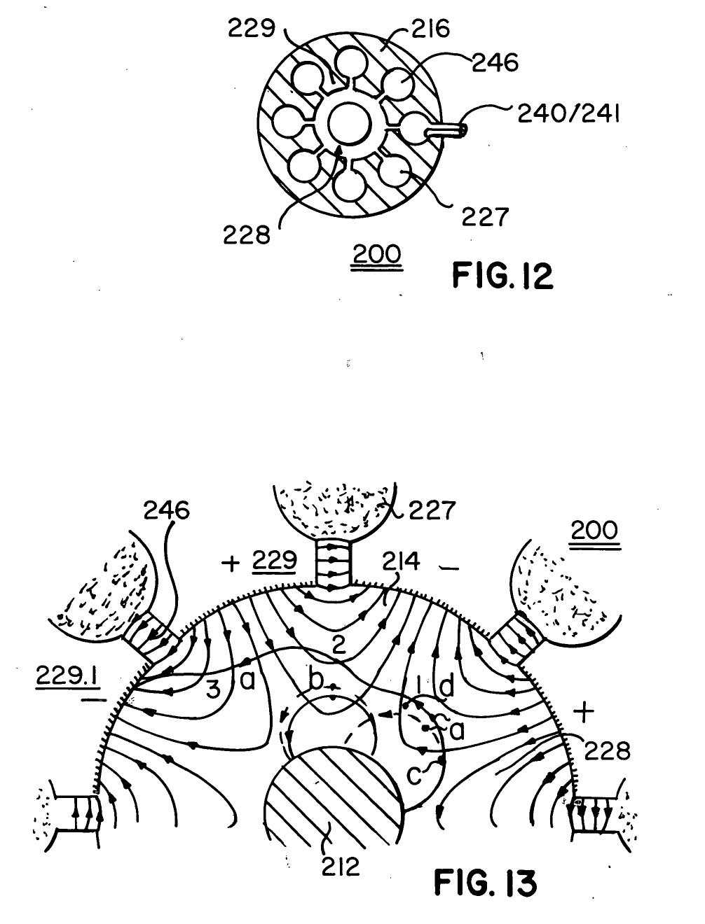

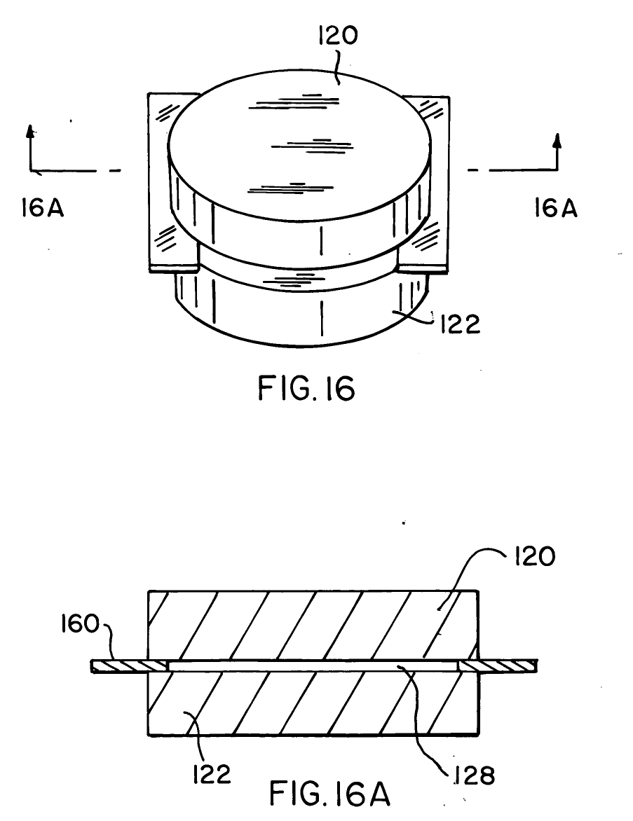

As noted in FIGS. 2, 5, and 12, an antenna 40 provides electromagnetic communication from said strapping 30/32 of said cavities 27 into said power port 41 which feeds the energy resultant of excited fins/stubs 26/126 into waveguide 42. This microwave energy of the cavities is channeled through a plurality of waveguides 42 (see FIG. 15), one for each magnetron 10, employed in the present system. In one application, waveguides 42 provide the energy to a boiler 48 at 2.455 MHz which is highly efficient frequency for the heating and evaporation of water or liquid 52.

This may then be used to power a turbine generator. It is to be noted that fluids other than water, such as a plasma, may be advantageously used in boiler 48, which may be suitable where more compact methods of power generation are required. Alternatively, a carbon load may be constructed, in lieu of boiler 48, to provide a concentration of heat from waveguides 42 to a local hot spot.

Said anode cavities in combination with said waveguides 42 are highly efficient conductors of energy and are capable of transporting wattage high enough to constitute a substitute for fossil fuel and to create a steam input to a turbine generator having an advantageous power-to-weight and power-to-cost ratios. It is also noted that gases other than air may be used within waveguides 42 where the chemistry of such gases is more advantageous for transport of energy. Alternatively, and most likely, said waveguides, as well as the above-described magnetrons themselves, will be vacuum sealed to minimize molecular interference with the above-described use of the beta emitting radio-isotope as the cathode of the magnetron.

It has been determined than nickel 63, where available, constitutes the best and most efficient fuel for use in the magnetron in a commercial application, this due to the fact that it produces a high volume of very high speed electrons. Subject to the refinement of the various operating parameters of the magnetron, the system utilizes beta ray electrons and the substantial, historically untapped energy of the beta voltaic effect associated with the magnetic fields of such electrons. Where nickel 63 is unavailable, many other beta-emitting isotopes exist. See U.S. Pat. No. 5,825,839, referenced above, to Baskis. However, most of such other isotopes also emit alpha and/or gamma radiation. Therein, one may selectively shield or filter out the undesired radiation to leave emission only of the desired beta ray electrons discussed above. Therefore, either method, whether entailing the direct use of isotopes such as nickel 63, or strontium 90 or iron 55, or the shielding out of other rays from numerous other isotopes, may be employed to achieve high volume, high speed beta electron emission. It is noted that the U.S. Department of Energy, in a project known as the Archimedes Separation Process, has developed a method for the separation, into discrete isotopes, of the constituent by-products of plutonium production. Using this process, nickel 63 and other isotopes may be cost-effectively extracted from rods of fission reactors and waste associated with production of plutonium. This technology is subject to U.S. Pat. Nos. 6,096,220 and 6,235,202 among others.

As may be appreciated, many isotopes which are by-products of nuclear fission have been stored, without any viable commercial use, for many years. However, as above noted, the magnetic separation process developed by the U.S. Department of Energy has resulted in a method of separation, into discreet isotopes, of a constituent isotopes of plutonium production. Accordingly, large stock piles of many discreet isotopes exist e.g., nickel 63, and more material may be cost-effectively obtained through this process.

It is to be appreciated that said waveguides 42, as in the case of said anode cavities 27, may assume various different geometries, depending upon application. Therein, frequency outputs of over 300 GHz have been obtained.

As a further application of the present invention, the output of waveguides 42 may be directly converted into DC electrical power through a system known as the Cyclotron Wave Converter (CWC), an example of which is set forth in the Journal of Radio-Electronics, No. 9, 1999, entitled “High Power Converter of Microwaves into DC” by Vanke, et al. The Vanke system also discusses the possibility of high efficiency wireless power generation by microwaves in which, at reception, the microwave energy is converted to DC power. Such a system entirely by-passes the steam turbine as a means of power generation.

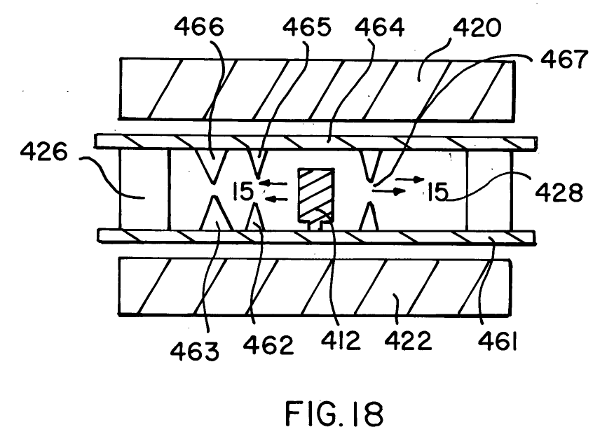

With reference to FIGS. 17 and 18 are shown a further embodiment of a magnetron 400 which resembles the embodiment of magnetron 100 (see FIGS. 3, 4, 6 and 10) in that it is also a slot magnetron including, particularly, slots 426, cavities 427 therebetween, a radial cross-sectional geometry defined by housing 416, an isotope cathode 412, and interaction space 428. The embodiment of FIGS. 17 and 18 however differs from that of magnetron 100 in its use of concentric grids 462 and 463, more fully shown in the vertical axial cross-sectional view of FIG. 18. In this embodiment, a single grid 462 may be employed which projects upward from a dielectric or inert rigid surface 461. As another option, a second grid 465, technically a part of a composite first grid, projects downwardly from upper dielectric or inert surface 464 as a result of such an appropriately biased grid 462, which may include said upper grid 465 disposed at a like radius from cathode 412. The path of high energy electrons 15 may be confined to an opening 467 between the teeth of the upper and lower grid and, more importantly, the velocity of said electrons may be retarded for purposes of optimizing the curvature of circular rotation thereof within interaction space 428 and, as well, of reducing the energy of electrons 15 to a level which is more practical to use within magnetron 400, that is, that will cause less damage to the physical structure of the device than would unretarded electrons. Where an additional level or degree of control of electron path and velocity is considered necessary, a second concentric lower grid 463, may be employed and a similar, but downwardly projecting grid 466, may be added. In this embodiment, the interaction space is the annular region 428 which is outward of the outer biasing structure 463/466 but inward of stubs 426 of the magnetron. Further shown in FIG. 18 are upper and lower magnets 420 and 422 respectively.

With reference to FIG. 19, there is shown a further embodiment 500 which comprises a Mayan pyramid-like structure having a number of discreet layers, each representing a separate magnetron and each consisting of the above-described three basic layers, namely, an upper magnet having a first magnetic polarity, an anode block, and a lower magnet of opposite magnetic polarity. Accordingly, each of the vertical layers of the embodiment of FIG. 19, denoted as layers 516A, 516B, 516C, 516D, 516E, and 516F are understood to include each of the above-described three basic layers of the inventive system, above described with reference to FIGS. 1-14. The embodiment 500 however differs in its use of a single cathode 512 which is shown as a single vertical rod in FIG. 19. This embodiment is also characterized by its use of a polar or horizontal slit in a grid which slit may repeat in a circular pattern about each of the constituent layers of FIGS. 16A-16F. In other words, slits 567 thru 572 each exhibit a different length or polar dimension, one purpose of which is to limit the integral of the energy of electrons that can escape through a given grid slit 567 thru 572 of a particular one of said layers 516A thru 516F. The rationale of this approach is to limit or control the total energy of a given group of emitted beta decay electrons to one which is suitable to the geometry and other operating parameters of the particular magnetron within each of said layers 516A thru 516F. Also, the energy of individual electrons which can escape through a given grid slit 567 to 572 is also affected by the strategy that the E×B vector will cause greater electron curvature (see FIG. 1) in the case of more energetic electrons. In view thereof, the topmost layer 516F and its corresponding small slit grid 572 would block more high energy electrons (because of their greater curvature) than would be the case at the other layers having larger slits. Conversely, where a cathode possesses an isotope which is weak in terms of either density of electron emission, position on the beta energy spectrum for that isotope, or in terms of mixture of the isotope with a non-isotope, for example for purposes of radiologic safety, then a layer 516A-E having a larger slit than slit 572 respectively, may be selected. It is to be appreciated that each of the individual layers of the embodiment of FIG. 19 may be produced or provided individually. It is however believed that applications exist in which it is more efficient to match a given anode geometry with a given emission velocity, density, energy integral, or E×B curvature, with the microwave outputs of different structures tied together to the intended load, rather than used individually.

Shown in FIG. 20 is a further embodiment 600 of the present invention This embodiment, like that of FIG. 19, employs a common anode rod 612 upon which are stacked groups 601 of a lower magnet 620, an anode block 616A, and an opposing magnet 622. Each group 601 is separated from the next successive group by a magnetically insulating layer 623. In this embodiment, as with the other embodiments above described, a dielectric 660 may be inserted within either or both the interaction space of anode block 616A or the anode cavities 627 of the anode block. These dielectrics, wherever positioned, may be tunable, as is known in the art of dielectrics, as taught in U.S. Pat. Nos. 6,774,077 and 7,060,636. The significance of use of a dielectric in the interaction space is that the extreme velocity and momentum of the beta decay electrons may be mediated and more readily adapted in radius of rotation about the cathode within the interaction space to achieve objectives of improved life of the structure and, where the dielectric is used within the anode cavities, to tune the LC equivalent circuit (see FIG. 9) of the cavity resonators to produce microwaves of optimal frequency for a given application and for impedance matching to a wave guide or other system output.

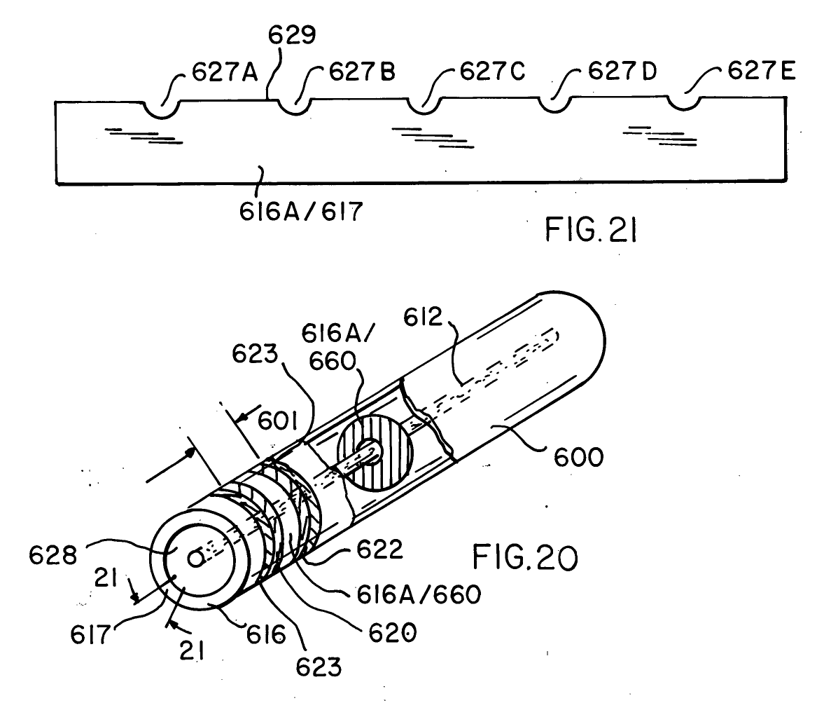

In FIG. 21 is shown a flattened polar sectional view, as indicated by curved arrows 21-21 in FIG. 20. FIG. 21 thereby shows that within a given segment 617 of anode block 616A may exist a plurality of cavities 627A-627E, each having an axis which is co-linear or parallel with the B vector of opposing magnet layers 620 and 622 (see FIG. 20). It is to be appreciated that said anode block 616A may be printed upon a flexible integrated circuit (IC) substrate as may be anode surfaces 629 between each of said anode cavities 627A-627E. After printing, the structure shown in FIG. 21 is simply bent into the annular form, as reflected in all embodiments of the invention. In this process, dielectric material 660 may be disposed within the interior radius of the anode block 616A when it is bent about cathode rod 612, or printed on the IC substrate. In this embodiment, the properties of dielectric 660 may be electronically modulated through the use of circuit chip to optimize the above discussed characteristics of electron emission, density, curvature and effective LC parameters of the anode cavities 627.

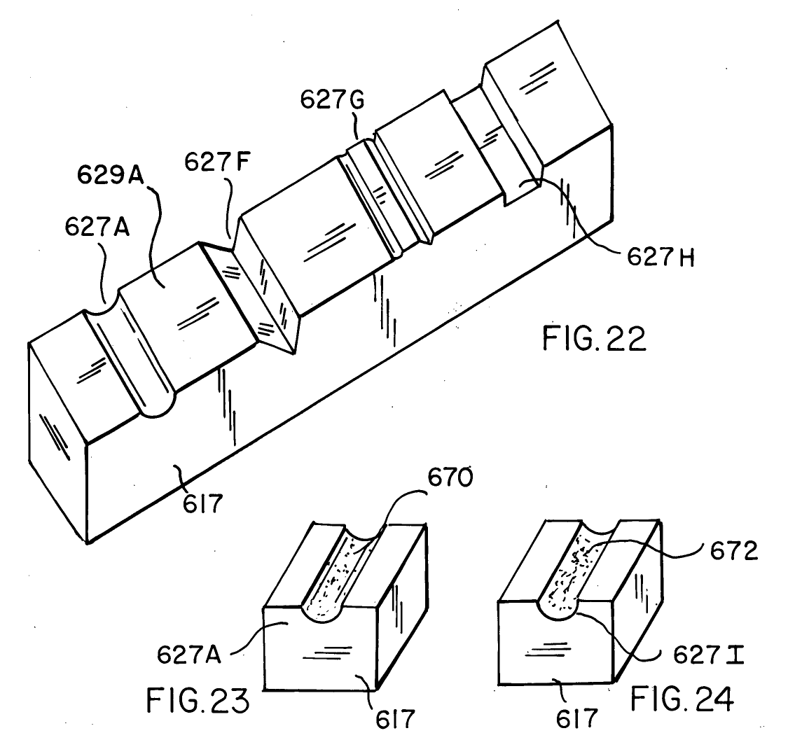

As may be noted in FIG. 22, a single anode block 617A, whether in the context of the embodiment of FIG. 20, or in connection with any of the other embodiments above, may employ anode cavities of differing cross-sectional geometries, for example, the geometries of cavities 627A, 627F, 627G, and 627H. Such different geometries will of course produce significant differences in microwaves resultant from them and will also affect the rotation of the election cloud within the interaction space. FIG. 22 also shows anode surfaces 629A separating the respective anode cavities.

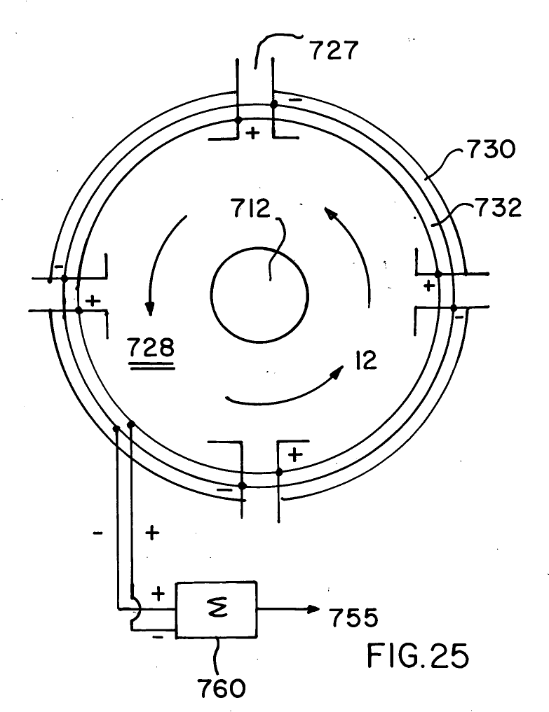

FIGS. 23 and 24 show that the durability, that is, effective life of the magnetron in any of the embodiments of the invention may be improved through the deposition of a highly durable material, such as industrial diamond or carbon 670 or 672 respectively upon the surface of anode cavities 670 or 671 respectively, shown in FIGS. 23 and 24. The deposition of such surfaces of a non-reactive material including carbon, silicone, titanium, or composites thereof will considerably increase the effective life of the anode structure relative to the system of Brown and others. In other words, maintaining of the smooth surfaces and geometric integrity of the magnetron, once properly tuned, is an essential aspect of the practice of the present invention.

In FIG. 25 is shown a schematic of a further embodiment 700 of the invention in which a polar array of antennae 727 are used as a functional equivalent of said anode cavities. Therein, a cathode 712 emits beta decay electrons 12 which, as in other embodiments, rotate within an interaction space 728. However, the resultant obtaining electron cloud induces the above-discussed LC values and excitation to antennae 727, as opposed to said cavities 27/127/227/327 of the other embodiments and induces positive and negative polarities. These polarities are strapped together by strapping means 730 and 732. Said antennae will resonate in like fashion to said cavities. Said strapping is used for purposes of phase lock, amplitude control and communication of output 725 to an optional power port, wave guides (not shown), and a power combiner 760.

It is to be appreciated that the principles of the present invention are equally applicable to use with a cathode characterized by the emission of alpha or gamma particles, providing appropriate shielding exists in the case of gamma radiation.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth.

1. A system for generation of electrical energy, in the absence of an external power supply the system comprising:
(a) a cathode comprising an axially disposed emitter of beta electrons resultant of an electro-weak decay of the quark structure of neutrons of an atomic nucleus of an isotope;
(b) an annular anode block, disposed in an axial plane and having an opposite electrical polarity relative to said cathode, forming between said cathode and anode block a radial electrical vector E, said anode block circumferentially disposed in said plane about said cathode, and having an interior radius relative to said cathode defining an annular interaction space, an outer periphery of said space defining a polar array of anode cavities in said block, separated from each other by anode surfaces, each cavity and surface together having an LC equivalent value, each cavity capable of generating a resonant frequency responsive to motion of said electrons past said anode surfaces and entrances to said anode cavities;
(c) upper and lower magnets, each of opposite polarity, each disposed in respective radial planes, above and below said anode block, in which opposing surfaces of said upper and lower magnets are in magnetic communication with said interaction space of said anode block, producing a DC magnetic vector B therebetween and axially across said anode block in a direction co-axial with each of said cavities within said anode block in which said beta electrons interact with an E×B vector, produced by said radial E vector and magnetic B vector, causing rotation of said electrons to form a rotating electron cloud within said annular interaction space, inducing microwave energy at LC resonant frequencies into said anode cavities; and
(d) a power port for feeding resonant microwave energy collected from said cavities assembly for conversion thereof into a power output of said system.

2. The system as recited in claim 32, further comprising:
means for selectably biasing said radial E vector by providing selectable DC voltages to said conduction block to thereby influence post-emission velocity of said electrons and velocity of said rotating electron cloud resultant of interaction between said electrons and said E×B vector.

3. The system as recited in claim 1, in which said assembly for conversion comprises:
wave guides for provision of said microwave energy to a liquid tank of a steam turbine.

4. The system as recited in claim 1, in which said assembly for conversion comprises:
a rectifier for providing DC conversion of microwave energy of said resonant frequencies to an electrical output of the system.

5. The system as recited in claim 1, in which said assembly comprises a wave guide having an output into a CWC system for direct conversion of microwave energy into a DC electrical output.

6. The system as recited in claim 32, further comprising:
conductive strapping elements, within said conduction block, providing connection between selected groups of said cavities at locations of like electrical polarity to improve integrity of said rotating electron cloud within said interaction space, the phase relation of the spokes of said rotation cloud, and uniformity of the amplitude of said spokes.
whereby cavity microwave energy may be more efficiently collected by said power port.

7. The system as recited in claim 1, in which said anode surfaces comprise:
fin-like structures defining said anode cavities therebetween, in which a polarity of each successive fin alternates between positive and negative during rotation of said electron cloud.

8. The system as recited In claim 1, in which said anode surfaces comprise:
stub-like structures defining said anode cavities therebetween, in which a polarity of each successive stub alternates between positive and negative during rotation of said electron cloud.

9. The system as recited in claim 32, in which said cavities each define a narrow radial input channel, between said conduction block surfaces of successive cavities, each channel enlarging radially outwardly within said block to form a semi-circular geometry thereof.

10. The system as recited in claim 32, in which said cavities each define semi-circular structures.

11. The system as recited in claim 1, in which said cathode comprises:
a single isotope having properties of weak force neutron decay.

12. The system as recited in claim 1, in which said cathode comprises:
a plurality of different isotopes, each having a different decay parameter.

13. The system as recited in claim 1, in which said interaction space includes a selectable dielectric material.

14. The system as recited in claim 1, in which one or more of said anode cavities includes a selectable dielectric material.

15. The system as recited in claim 14, in which properties of said dielectric material are tunable for purposes of selecting an LC value of each cavity, including frequency tuning and impedance matching with said power port.

16. The system as recited in claim 1, further comprising: a dielectric layer separating said upper and lower magnets, said layer disposed radially outwardly of said interaction space.

17. The system as recited in claim 13, in which said dielectric material comprises:
a part of a rigid layer separating said upper and lower magnets.

18. The system as recited in claim 1, further comprising:
one or more electrically biased grids, each disposed concentrically about said cathode within said interaction space to influence emission parameters of electrons, within an energy spectrum of emitted isotopic electrons, to a level acceptable for purposes of a rotational radius, integrity of said electron cloud in said interaction space, velocity and density of electron cloud rotation, and to impart effective LC values to said anode cavities and spaces.

19. The system as recited in claim 18, in which each of said grids depends axially upwardly or downwardly from a rigid dielectric base abutting one or both of said upper or lower magnets.

20. The system as recited in claim 19, in which a geometry or bias of one of said concentric grids may differ from that of another.

21. The system as recited in claim 1, comprising:
layers of said system axially disposed upon each other, each layer upon a cathode common to all layers, including an insulating layer between each successive group of north magnet layer, anode block layer, and south magnet layer.

22. The system as recited in claim 1, comprising:
magnet and anode block layers of said system axially disposed upon each other, all layers thereof having a common cathode, and an insulating layer between each magnet-anode block-magnet group in which one or more of said interaction block layers of each group comprises a slit-like grid surrounding said cathode, a dimension and geometry of said slit functioning to the limit escape of isotopic electrons to desired energy ranges, this to optimize electron emission velocity, desired rotational radius in the interaction space, properties of said rotating electron cloud, and providing desired LC parameters to said anode cavities and surfaces of said anode block.

23. The system as recited in claim 1, further comprising:
a dielectric material disposed concentrically about said cathode within said interaction space to influence the emission characteristic of electrons, within an energy spectrum emitted by said isotopic electrons, to one acceptable for purposes of rotational radius, integrity of said electron cloud in said interaction space, and velocity and density of electron cloud rotation to impart effective LC values to said anode cavities and spaces.

24. The system as recited in claim 18, further comprising: tunable dielectric materials disposed within one or more of said anode cavities.

25. The system as recited in claim 7, said fin-like structures printable upon a flexible substrate which may be bent into a circular geometry having an internal radius corresponding to a desired radius of said interaction space of said anode block.

26. The system as recited in claim 22, further comprising: a dielectric material disposed concentrically about said cathode within said interaction space to influence the emission characteristic of electrons, within an energy spectrum emitted by said isotopic electrons, to one acceptable for purposes of rotational radius, integrity of said electron cloud in said interaction space, and velocity and density of electron cloud rotation to impart effective LC values to said anode cavities and spaces.

27. The system as recited in claim 24, further comprising: a dielectric material disposed concentrically about said cathode within said interaction space to Influence the emission characteristic of electrons, within an energy spectrum emitted by said Isotopic electrons, to one acceptable for purposes of rotational radius, integrity of said electron cloud in said interaction space, and velocity and density of electron cloud rotation to impart effective LC values to said anode cavities and spaces.

28. The system as recited in claim 32, in which said interaction space includes a gas.

29. The system as recited in claim 1, in which said cathode includes secondary electron emitters.

30. A system for generation of electrical energy, the system comprising:
(a) a cathode comprising an axially disposed emitter of beta electrons resultant of an electro-weak decay of the quark structure of neutrons of an atomic nucleus of an isotope;
(b) a polar array of antennae, disposed in an axial plane and having an opposite electrical polarity relative to said cathode, forming between said cathode and antennae a radial electrical vector E, said antennae circumferentially disposed in said plane about said cathode, and said array having an interior radius relative to said cathode and inward of said antennae, defining an annular interaction space, said antennae separated from each other, each antenna of said array having an LC equivalent value, each antenna capable of generating a resonant frequency responsive to motion of said electrons past a plurality of structures of each antenna;
(c) upper and lower magnets, each of opposite polarity, each disposed in respective radial planes, above and below said array, in which opposing surfaces of said upper and lower magnets are in magnetic communication with said interaction space, producing a DC magnetic vector B therebetween and axially across said array in a direction co-axial with certain members of said plurality of structures of each antenna, in which said electrons interact with an E×B vector, produced by said electrical and magnetic vectors, causing rotation of said electrons to form a rotating electron cloud within said annular interaction space, inducing microwave energy at LC resonant frequencies onto said antenna; and
(d) a power port for feeding resonant microwave energy collected from said antenna for conversion thereof into a power output of said system.

31. The system as recited in claim 30, further comprising: conductive strapping elements, within said array, providing connection between selected groups of said antennae at locations of like electrical polarity, to improve integrity of said rotating electron cloud within said interaction space, the phase relation of the spokes of said electron cloud, and uniformity of amplitude of said spokes of said cloud,
whereby resultant system microwave energy may be efficiently collected by said power port.

32. A system for generation of electrical energy, the absence of an external power supply the system comprising:
(a) an axially disposed emitter of alpha or beta electrons resultant of an electro-weak decay of the quark structure of neutrons of an atomic nucleus of an isotope;
(b) an annular conduction block, disposed in an axial plane and having an opposite electrical polarity relative to said emitter of said electrons, forming between said emitter and conduction block a radial electrical vector E, said conduction block circumferentially disposed in said plane about said emitter, and having an interior radial periphery relative to said emitter, defining an annular interaction space, an outer periphery of said space defining a polar array of cavities in said block, separated from each other by surfaces in communication with said interaction space, each cavity and surface together having an LC equivalent value, each cavity capable of generating a resonant frequency responsive to annular motion and energy of said electrons passing said surfaces and entrances to said cavities;
(c) upper and lower magnets, each of opposite polarity, each disposed in respective radial planes, above and below said conduction block, in which opposing surfaces of said upper and lower magnets are in magnetic communication with said interaction space producing a DC magnetic vector B axially across said block in a direction co-axial with each of said cavities within said block in which said alpha or beta electrons interact with an E×B vector, produced by said radial electrical vector E and magnetic vector B, causing rotation of said electrons transversely to said vector to form a rotating electron cloud within said annular interaction space, inducing microwave energy at LC resonant frequencies into said block cavities; and
(d) a power port for feeding resonant microwave energy collected from said cavities for conversion of said energy into a power output of said system.

33. The system as recited in claim 1, further comprising:
means for selectably biasing said radial E vector by providing selectable DC voltages to said conduction block to thereby influence post-emission velocity of said electrons and velocity of said rotating electron cloud resultant of interaction between said electrons and said E×B vector.
